(19) United States
(12) Patent Application Publication
(10) Pub. No.: US 2012/0253579 A1
(43) Pub. Date: Oct. 4, 2012

(54) Range Extender for a Motor Vehicle

(75) Inventor: Hans-Peter Groeter, Vaihingen (DE)

(73) Assignee: Robert Bosch GmbH, Stuttgart (DE)

(21) Appl. No.: 13/516,539

(22) PCT Filed: Dec. 10, 2010
(86) PCT No.: PCT/EP10/69333

§ 371 Date: Jun. 15, 2012

(30) Foreign Application Priority Data
Dec. 17, 2009 (DE) 10 2009 054 839.4

(51) Int. Cl. B60W 20/00

(52) U.S. Cl. 701/22; 180/65.265; 903/930

(57) ABSTRACT

A method for operating an internal combustion engine-generator unit as a range extender, includes generating mechanical energy in a combustion engine, converting the mechanical energy into electric alternating current in a generator, rectifying the alternating current into direct current, and controlling the voltage of the direct current in an open-loop and/or closed-loop manner. The voltage of the direct current is carried out by controlling the rotational speed of the generator in an open-loop and/or closed-loop manner.

The present invention relates to a method for operating an internal combustion engine-generator unit as claimed in the preamble of claim 1, an internal combustion engine-generator unit as claimed in the preamble of claim 5 and a hybrid drive device as claimed in the preamble of claim 9.

### PRIOR ART

The motor vehicle industry is increasingly developing and/or manufacturing motor vehicles which are driven by an electric motor. In such a motor, the electrical energy for operating the electric motor to drive the electric vehicle originates from a battery arranged in the electric vehicle. The battery is charged from a power grid here while the electric vehicle is stationary. The electric vehicle comprises for this purpose a charging device. The capacity for storing electrical energy in the battery is limited here, with the result that ranges in the range of only approximately 50 km to 200 km can be reached by the electric vehicle. In order to increase the range of the electric vehicle, said vehicle is provided with what is referred to as a range extender, an internal combustion engine-generator unit. In the case of relatively long distances with the electric vehicle during which the battery cannot be charged or cannot be sufficiently charged by a power grid, the battery is charged by means of the internal combustion engine-generator unit and/or electric current is fed to the electric motor by means of the internal combustion engine-generator unit. As a result, the possible range of such an electric vehicle with a range extender can be increased to ranges up to approximately 600 km, corresponding to a range of conventional motor vehicles which are driven exclusively with an internal combustion engine.

In particular in the case of permanent-magnet-excited electric machines as generators in the internal combustion engine-generator unit, the alternating voltage which is generated by the generator or the alternating current is converted into a direct current and in addition the voltage of the direct current is also regulated using a pulse-controlled inverter. The control of the voltage of the direct current generated by the internal combustion engine-generator unit is necessary because in order to charge the battery the generated voltage from the internal combustion engine-generator unit has to be higher than the battery voltage. The battery voltage depends here on the charge state and load state of the battery of the motor vehicle. However, such a pulse-controlled inverter is disadvantageously expensive to acquire and also susceptible to inference.

DE 10 2008 039 907 presents a vehicle having an energy source, an electrical energy store, a generator which is designed to generate electrical energy and to charge the electrical energy store, an electric traction motor and an activation device which is designed to switch on and/or switch off the energy source, wherein by a starter device with a control element which initiates the switching on and/or the switching off of the energy source by the activation device, wherein the control element is designed in such a way that it permits initiation without the driver having to be in the vehicle at the time of the initiation.

### DISCLOSURE OF THE INVENTION

### Advantages of the Invention

Method according to the invention for operating an internal combustion engine-generator unit as a range extender, comprising the following steps: generating mechanical energy in an internal combustion engine, converting the mechanical energy into electric alternating current in a generator, rectifying the alternating current into direct current, performing open-loop and/or closed-loop control of the voltage of the direct current, wherein the voltage of the direct current is carried out by performing open-loop and/or closed-loop control of the rotational speed of the generator. The voltage of the direct current is carried out by performing open-loop and/or closed-loop control of the rotational speed of the generator. It is therefore not necessary to perform open-loop and/or closed-loop control of the voltage of the direct current by means of a complex and expensive pulse-controlled inverter. This is easily carried out by virtue of the fact that open-loop and/or closed-loop control of the rotational speed of the generator is performed because the alternating current voltage which is generated by the generator is dependant on the rotational speed of the generator.

In particular, the voltage of the direct current is carried out exclusively by performing open-loop and/or closed-loop control of the rotational speed of the generator.

In a further embodiment, open-loop and/or closed-loop control of the rotational speed of the generator is performed, in particular exclusively, by means of the rotational speed of the internal combustion engine. The generator is connected to the internal combustion engine by means of a drive shaft. The rotational speed of the generator therefore depends on the rotational speed of the internal combustion engine.

In a further embodiment, the rotational speed of the generator is controlled by virtue of the fact that the rotational speed of the generator is controlled independently of the rotational speed of the internal combustion engine by means of a transmission which connects the internal combustion engine and the generator to one another.

In a supplementary embodiment, the alternating current is converted into direct current by an uncontrolled rectifier.

Internal combustion engine-generator unit according to the invention as a range extender, comprising: an internal combustion engine, a generator, preferably a fuel tank, a rectifier for rectifying the alternating current generated by the generator into direct current, a device for performing open-loop and/or closed-loop control of the voltage of the direct current made available by the rectifier, wherein the rectifier is an uncontrolled rectifier. The internal combustion engine-generator unit therefore does not comprise a pulse-controlled inverter for rectifying the alternating current generated by the generator into direct current and/or for performing open-loop and/or closed-loop control of the voltage of the direct current. The uncontrolled rectifier is significantly more economical to acquire than a complex and relatively expensive pulse-controlled inverter. As a result, the costs for acquiring the pulse-controlled inverter can be avoided and nevertheless it is possible to perform open-loop or closed-loop control of the voltage of the direct current.

The device is preferably a control unit for performing open-loop and/or closed-loop control of the rotational speed of the internal combustion engine or of the generator. If the device performs open-loop and/or closed-loop control of the rotational speed of the generator, the device is, for example, a transmission by means of which the rotational speed of the generator is decoupled from the rotational speed of the internal combustion engine. The internal combustion engine therefore drives the generator by means of the transmission, and open-loop and/or closed-loop control of the rotational speed of the generator can be performed by means of the transmission. In contrast to this, the device is a control unit for performing open-loop and/or closed-loop control of the rotational speed of the internal combustion engine. For this purpose, the internal combustion engine is mechanically connected to the generator by means of a drive shaft, and the rotational speed of the generator corresponds to the rotational speed of the internal combustion engine, or the rotational speed of the generator has a constant ratio to the rotational speed of the internal combustion engine.

In one variant, the generator is a, preferably permanent-magnet-excited, synchronous electric machine.

In a further refinement, a method which is described in this patent application can be carried out by the internal combustion engine-generator unit.

Hybrid drive device according to the invention for a motor vehicle comprising: at least one electric motor for driving the motor vehicle, a battery, an internal combustion engine-generator unit as a range extender for charging the battery and/or for generating electrical energy for the at least one electric motor, wherein a method described in this patent application can be carried out.

In a further embodiment, the hybrid drive device comprises a control unit, in particular for the motor vehicle, and open-loop and/or closed-loop control of the rotational speed of the internal combustion engine can be performed by means of the control unit, with the result that open-loop and/or closed-loop control of the voltage of the direct current made available by the internal combustion engine-generator unit can be performed as a function of the rotational speed of the internal combustion engine.

In a further refinement, the internal combustion engine-generator unit of the hybrid drive device is embodied as an internal combustion engine-generator unit described in this patent application.

In a further refinement, the hybrid drive device comprises a battery management system, and a setpoint value of a direct voltage for charging the battery can be predefined by the battery management system.

### BRIEF DESCRIPTION OF THE DRAWINGS

In the text which follows, an exemplary embodiment of the invention is described in more detail with reference to the appended drawings, in which:

FIG. 1 shows a schematic system diagram of an internal combustion engine-generator unit as a range extender,

FIG. 2 shows a schematic system diagram of a hybrid drive device, and

FIG. 2 shows a view of a hybrid vehicle.

### EMBODIMENTS OF THE INVENTION

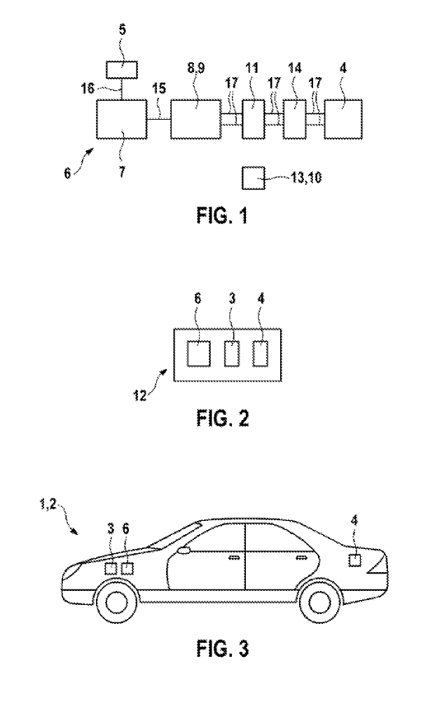

In electric vehicles 1 or hybrid vehicles 2 which are operated exclusively by an electric motor 3 by means of electrical energy from a battery 4, an internal combustion engine-generator unit 6 is used to extend the range of the electric vehicle 1. Mechanical energy is generated by an internal combustion engine 7 by means of the internal combustion engine-generator unit 6 as what is referred to as a range extender 6 by means of fuel from a fuel tank 5 which is fed through a fuel line 16, said mechanical energy being converted into electrical energy by a generator 8 as a permanent-magnet-excited synchronous machine 9. The internal combustion engine 7 is mechanically connected to the generator 8 by means of a drive shaft 15 (FIG. 1). The generator 8 generates alternating current which is converted by an uncontrolled rectifier 11 into direct current. Either the battery 4 is charged or the electric motor 3 is operated by means of the electrical energy from the generator 8. As a result, the range of the electric vehicle 1 can be extended significantly, for example to ranges in the range of approximately 300 km to 600 km. The range of the electric vehicle 1 by means of electrical energy from the battery 4 is, for example, in the range of 50 km to 150 km.

The direct current which is generated by the rectifier 11 is fed to a battery management system 14 before the direct current for charging the battery 4 is fed. The generator 8 as a synchronous machine 9, the uncontrolled rectifier 11, the battery management system 14 and the battery 4 are connected to one another here by means of power lines 17. In order to charge the battery 4 of the electric vehicle or hybrid vehicle 1, 2 (FIG. 3) is is necessary for the direct current voltage made available by the rectifier 11 to be higher than the voltage of the battery 4. The voltage of the battery 4 depends here on the charge state or load state of the battery 4. A control unit 13 receives a setpoint value for the voltage of the direct current for charging the battery 4 from the battery management system 14 by means of control lines (not illustrated). By means of this setpoint value, open-loop and/or closed-loop control of the rotational speed of the internal combustion engine 7 is performed by the control unit 13 as a device 10 for controlling the voltage of the direct current. The higher the rotational speed of the internal combustion engine 7, and therefore also of the generator 8, owing to the mechanical coupling merely by means of the drive shaft 15, the higher the voltage of the alternating current made available by the generator 8. The higher the voltage of the alternating current made available by the generator 8, the higher the voltage of the direct current made available by the rectifier 11, and vice versa. Open-loop and/or closed-loop control of the voltage of the current rectified by the rectifier 11 for charging the battery can therefore be performed exclusively by the open-loop and/or closed-loop control of the rotational speed of the internal combustion engine 7 and therefore also of the generator 8.

In a further exemplary embodiment (not illustrated) of the internal combustion engine-generator unit 6, the internal combustion engine 7 is connected to the generator 8 by means of a transmission. The open-loop and/or closed-loop control of the rotational speed of the generator 8 can be performed by means of this transmission independently of the rotational speed of the internal combustion engine 7, and therefore also open-loop and/or closed-loop control of the voltage of the direct current made available by the rectifier 11 can be performed. The control unit 13 controls the rotational speed of the generator 8, and therefore also the voltage of the direct current made available by the rectifier 11 by means of the transmission (not illustrated).

FIG. 3 illustrates an electric vehicle or hybrid vehicle 1, 2. The hybrid vehicle 2 is driven exclusively by an electric motor 3, and the electrical energy for driving the electric vehicle 1 originates from the battery 4. In order to increase the range of the electric vehicle 1, the internal combustion engine-generator unit 6 is installed in the electric vehicle 1 or hybrid vehicle 2 according to FIG. 1. As a result, the range of the hybrid vehicle 2 can be extended to ranges in the range of approximately 300 to 600 km. Either the battery 4 can be charged and/or the electric motor 3 for driving the electric vehicle 1 or hybrid vehicle 2 or providing traction to said electric vehicle 1 or hybrid vehicle 2 can be operated by means of the electric current made available by the generator 8.

Considered overall, significant advantages are associated with the internal combustion engine-generator unit according to the invention. The voltage of the current made available by the rectifier 11 is controlled by performing open-loop and/or closed-loop control of the rotational speed of the generator 8. As a result, a relatively complex and expensive pulse-controlled inverter for performing open-loop and/or closed-loop control of the voltage of the direct current is not necessary because all that is necessary is an uncontrolled rectifier 11 to make available direct current. The open-loop and/or closed-loop control of the voltage level is performed by means of the open-loop and/or closed-loop control of the rotational speed of the generator 8.

1. A method for operating an internal combustion engine-generator unit as a range extender, comprising:
generating mechanical energy in an internal combustion engine;
converting the mechanical energy into electric alternating current in a generator;
rectifying the alternating current into direct current; and
performing open-loop and/or closed-loop control of the voltage of the direct current,
wherein the voltage of the direct current is carried out by performing open-loop and/or closed-loop control of the rotational speed of the generator.

2. The method as claimed in claim 1, wherein the voltage of the direct current is carried out exclusively by performing open-loop and/or closed-loop control of the rotational speed of the generator.

3. The method as claimed in claim 1, wherein open-loop and/or closed-loop control of the rotational speed of the generator is performed exclusively by means of the rotational speed of the internal combustion engine.

4. The method as claimed in claim 1, wherein the alternating current is converted into direct current by an uncontrolled rectifier.

5. An internal combustion engine-generator unit as a range extender, comprising:
an internal combustion engine;
a generator;
a fuel tank;
a rectifier for rectifying the alternating current generated by the generator into direct current; and
a device for performing open-loop and/or closed-loop control of the voltage of the direct current made available by the rectifier,
wherein the rectifier is an uncontrolled rectifier.

6. The internal combustion engine-generator unit as claimed in claim 5, wherein the device is a control unit for performing open-loop and/or closed-loop control of the rotational speed of the internal combustion engine or of the generator.

7. The internal combustion engine-generator unit as claimed in claim 5, wherein the generator is a permanent-magnet-excited synchronous electric machine.

8. The internal combustion engine-generator unit as claimed in claim 5, wherein:
the internal combustion engine is configured to generate mechanical energy,
the generator is configured to convert the mechanical energy into electric alternating current,
the rectifier is configured to rectify the alternating current into direct current,
the device performs open-loop and/or closed-loop control of the voltage of the direct current, and
the voltage of the direct current is carried out by performing open-loop and/or closed-loop control of the rotational speed of the generator.

9. A hybrid drive device for a motor vehicle comprising:
at least one electric motor for driving the motor vehicle;
a battery; and
an internal combustion engine-generator unit as a range extender for charging the battery and/or for generating electrical energy for the at least one electric motor,
wherein the internal combustion engine-generator unit is configured to generate mechanical energy,
wherein the internal combustion engine-generator unit is configured to convert the mechanical energy into electric alternating current,
wherein a rectifier is configured to rectify the alternating current into direct current,
wherein open-loop and/or closed-loop control of the voltage of the direct current is performed, and
wherein the voltage of the direct current is carried out by performing open-loop and/or closed-loop control of the rotational speed of the internal combustion engine-generator unit.

10. The hybrid drive device as claimed in claim 9, wherein:
the hybrid drive device comprises a control unit for the motor vehicle, and
open-loop and/or closed-loop control of the rotational speed of the internal combustion engine can be performed by means of the control unit, with the result that open-loop and/or closed-loop control of the voltage of the direct current made available by the internal combustion engine-generator unit can be performed as a function of the rotational speed of the internal combustion engine.

11. The hybrid drive device as claimed in claim 9, wherein the internal combustion engine-generator unit includes (i) an internal combustion engine, (ii) a generator, (iii) a fuel tank, (iv) an uncontrolled rectifier configured to rectify the alternating current generated by the generator into direct current, and (v) a device for performing open-loop and/or closed-loop control of the voltage of the direct current made available by the rectifier.

12. The hybrid drive device as claimed in claim 9, wherein:
the hybrid drive device comprises a battery management system, and
a setpoint value of a direct voltage for charging the battery can be predefined by the battery management system.
